(19) United States
(12) Patent Application Publication
(10) Pub. No.: US 2026/0184444 A1
(43) Pub. Date: Jul. 2, 2026

(54) SATELLITE DE-ORBITING SYSTEM

(71) Applicant: AEROJET ROCKETDYNE, INC., Melbourne, FL (US)

(72) Inventor: Brian P. Boyce, Sacramento, CA (US)

(21) Appl. No.: 19/131,612

(22) PCT Filed: Mar. 7, 2023
(86) PCT No.: PCT/US2023/014689

§ 371 Date: May 21, 2025

(51) Int. Cl. B64G 1/62; B64G 1/24; B64G 1/26; B64G 1/36; G05D 1/633; G05D 109/40; H04N 23/20

(52) U.S. Cl. CPC B64G 1/62; B64G 1/242; B64G 1/244; B64G 1/26; B64G 1/36; G05D 1/633; G05D 2109/40; H04N 23/20

(57) ABSTRACT

A satellite de-orbiting device including at least one thruster, at least one sensor, and a controller configured to communicate with the at least one thruster and the at least one sensor. The de-orbiting device is configured to be attached to a satellite, and the at least one sensor is operable to communicate signals to the controller that are representative of at least one of temperature of a satellite, position of a satellite, movement characteristics of a satellite, or communication status of a satellite. The controller is configured to activate the at least one thruster for de-orbiting based on at least one of the temperature, the position, the movement characteristics, or the communication status.

### TECHNICAL FIELD

The present disclosure relates to satellite de-orbiting systems for removing an artificial satellite from space.

### BACKGROUND

Artificial satellites that are launched into Earth's orbit may eventually need to be removed from orbit to limit the accumulation of orbital space debris. For example, a satellite may be de-orbited at the end of its useful life, at the end of its mission, or because it ceases to be operational.

Some current satellite designs rely on the satellite primary propulsion system and controller for de-orbiting. This requires, however, that there is a sufficient amount of fuel for propulsion. In that regard, not only must there be fuel, but the satellite propulsion system, controller, and other subsystems must be operational to accomplish de-orbiting.

### SUMMARY OF THE INVENTION

In one exemplary embodiment a satellite de-orbiting device includes at least one thruster, at least one sensor, and a controller configured to communicate with the at least one thruster and the at least one sensor. The de-orbiting device is configured to be attached to a satellite, and the at least one sensor is operable to communicate signals to the controller that are representative of at least one of temperature of a satellite, position of a satellite, movement characteristics of a satellite, or communication status of a satellite. The controller is configured to activate the at least one thruster for de-orbiting based on at least one of the temperature, the position, the movement characteristics, or the communication status.

In another example of the above described satellite de-orbiting device the signals are representative of the temperature.

In another example of any of the above described satellite de-orbiting devices the controller is configured to activate the at least one thruster in response to the temperature being below a temperature threshold for a continuous length of time that is greater than a temperature time threshold.

In another example of any of the above described satellite de-orbiting devices the sensor includes an infrared camera.

In another example of any of the above described satellite de-orbiting devices the signals are representative of the position and the movement characteristics.

In another example of any of the above described satellite de-orbiting devices the controller is configured to activate the at least one thruster in response to the position and the movement characteristics deviating from an orbital parameter data for a continuous length of time that is greater than an orbital parameter time threshold.

In another example of any of the above described satellite de-orbiting devices the movement characteristics comprise an acceleration, the signals represent the acceleration, and the controller is configured to activate the at least one thruster in response to the acceleration being zero for a continuous length of time that is greater than an acceleration time threshold.

In another example of any of the above described satellite de-orbiting devices the signals are representative of the communication status, and the controller is configured to activate the at least one thruster in response to the communication status indicating an absence of outbound communication for a continuous length of time that is greater than an outbound communication time threshold.

In another example of any of the above described satellite de-orbiting devices the de-orbiting device further includes a battery connected to the controller and the at least one sensor.

Another example of any of the above described satellite de-orbiting devices further includes an electric current sensor operable to communicate current signals that are representative of a status of an electrical system to the controller, and the controller is configured to activate the at least one thruster in response to the status of the electrical system indicating an absence of electrical activity for a continuous length of time that is greater than an electrical activity time threshold.

In another example of any of the above described satellite de-orbiting devices the controller includes a timer that has an expiration time period, and the controller is configured to activate the at least one thruster in response to the expiration time period elapsing.

In another example of any of the above described satellite de-orbiting devices the controller is configured receive a periodic satellite health signal, the presence of which is indicative of satellite operability, and the controller is configured to activate the at least one thruster in response to an absence the satellite health signal for a continuous length of time that is greater than a health signal time threshold.

In another example of any of the above described satellite de-orbiting devices the controller is configured to receive avoidance signals that are indicative of a potential collision, and the controller is configured to activate the at least one thruster in response to the avoidance signals.

In another example of any of the above described satellite de-orbiting devices the controller is configured to activate the at least one thruster in response to an external instruction signal.

An exemplary method for de-orbiting a satellite includes monitoring at least one of a temperature of a satellite, position of a satellite, movement characteristics of a satellite, or communication status of a satellite. The method further includes initiating a de-orbiting sequence responsive to at least one of: the temperature being below a temperature threshold for a continuous length of time that is greater than a temperature time threshold, the position and the movement characteristics deviating from an orbital parameter data for a continuous length of time that is greater than an orbital parameter time threshold, or the communication status indicating an absence of outbound communication for a continuous length of time that is greater than an outbound communication time threshold.

Another example of the above described exemplary method for de-orbiting a satellite further includes attaching a de-orbiting device to a satellite.

In another example of any of the above described methods for de-orbiting a satellite the monitoring includes using a sensor on the de-orbiting device to communicate signals that are representative of the temperature, the position, the movement characteristics, or the communication status to a de-orbiting device controller, the initiating includes the de-orbiting device controller initiating the de-orbiting sequence based on the signals, and the de-orbiting sequence includes activating a thruster on the de-orbiting device.

An exemplary system includes a satellite and a de-orbiting device attached to the satellite. The de-orbiting device includes at least one thruster, at least one sensor, and a controller communicating with the at least one thruster and the at least one sensor. The at least one sensor is operable to communicate signals to the controller that are representative of at least one of temperature of the satellite, position of the satellite, movement characteristics of the satellite, or communication status of the satellite. The controller is configured to activate the at least one thruster for de-orbiting based on at least one of the temperature, the position, the movement characteristics, or the communication status.

In another example of the above described system the satellite includes a satellite controller, and wherein the controller of the de-orbiting device is autonomous relative to the satellite controller.

In another example of any of the above described systems the satellite includes at least one thruster, the at least one thruster of the de-orbiting device including a higher thrust rating than the at least one thruster of the satellite.

### BRIEF DESCRIPTION OF THE DRAWINGS

The various features and advantages of the disclosed examples will become apparent to those skilled in the art from the detailed description. The figures that accompany the detailed description can be briefly described as follows:

FIG. 1 schematically illustrates a satellite de-orbiting system.

FIG. 2 illustrates a method of de-orbiting a satellite.

### DETAILED DESCRIPTION

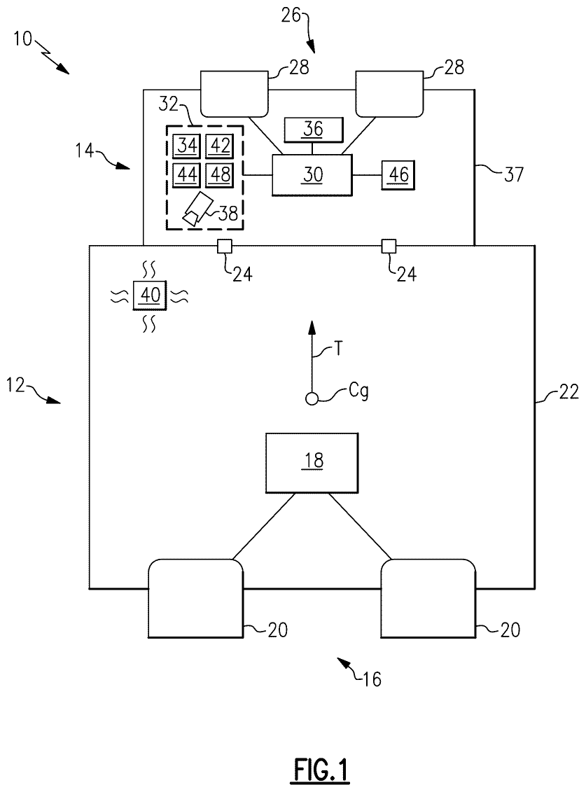

FIG. 1 schematically illustrates a satellite de-orbiting system 10 that includes a satellite 12 and a de-orbiting device 14 attached to the satellite 12. The satellite 12 includes a satellite propulsion system 16 and a satellite controller 18. In an example, the satellite propulsion system 16 includes a plurality of thrusters 20 that control motion and orientation of the satellite 12. In an example, the satellite controller 18 is a general satellite systems controller including specialized hardware or software enabling the satellite controller 18 to provide operational control to the satellite propulsion system 16. The satellite 12 may include a housing 22 which contains and/or mounts the satellite controller 18 and the satellite propulsion system 16.

The satellite 12 may be launched into low Earth orbit (LEO) or geostationary orbit by known methods. The satellite 12 may perform a useful function such as, but not limited to, communication relay, weather forecasting, navigation (GPS), broadcasting, scientific research, or Earth observation. The satellite 12 may be a CubeSat, small-scale satellite, large-scale satellite.

The de-orbiting device 14 is attachable to the satellite 12 prior to launch. In an example, the de-orbiting device 14 is removably attachable to the satellite 12 by one or more attachments 24. The attachments 24 may include, for example, fasteners, straps, tethers, adhesive, or any other appropriate attachment.

The de-orbiting device 14 includes a propulsion system 26. In an example, the propulsion system 26 of the de-orbiting device 14 includes solid-propellant thrusters 28. In other examples, the thrusters 28 are monopropellant thrusters, bipropellant thrusters, ion thrusters or Hall thrusters. The propulsion system 26 is configured to activate and generate thrust and thereby change the orbital parameters of the satellite 12 that the de-orbiting device 14 is attached to. In an example, the thrusters 28 are independently moveable to provide a thrust vector T in a desired direction. The de-orbiting device 14 may be mounted to the satellite 12 such that thrust vectors T produced by the propulsion system 26 extend through a center of gravity C_{g} of the satellite 12.

The de-orbiting device 14 provides a separate, stand-alone device operable to removing the satellite 12 from Earth's orbit. De-orbiting of satellite 12 generally refers to removing the satellite 12 from its current orbital path, and in some instances setting the satellite 12 on a path for reentry into Earth's atmosphere. De-orbiting may be desirable if the satellite 12 has concluded its intended mission or if the satellite 12 has become, or is anticipated to become, inoperable. Such voluntary de-orbiting avoids the accumulation of space debris.

Accordingly, to facilitate such desirable de-orbiting, the de-orbiting device 14 further includes a device controller 30 and a sensor system 32 that has at least one sensor. The sensor system 32 is configured to monitor one or more health characteristics of the satellite 12 and operates in cooperation with the device controller 30 to identify a condition or conditions that indicate de-orbiting. The device controller 30 is configured to activate the thrusters 28 of the propulsion system 26 to de-orbit the satellite 12 in response to the detected de-orbiting indications.

The sensor system 32 is operable to communicate signals to the controller that are representative of a status of the satellite 12. The sensor system 32 generally includes a positioning sensor 34. The positioning sensor 34 may be a gyroscope or an inertial measurement unit (IMU) and is operable to communicate signals that are representative of the position (i.e., angular orientation, location in space) and/or movement characteristics (i.e., acceleration vectors, velocity vectors, rate of rotation) of the satellite 12.

The device controller 30 of the de-orbiting device 14 is configured to communicate with the propulsion system 26 and the sensor system 32. The device controller 30 is configured to activate and control the propulsion system 26 based on signals received from the sensor system 32. For example, the positioning sensor 34 may communicate position and movement characteristics relating to the current orbital parameters of the satellite 12, and the device controller 30 may analyze that information to determine when and how to activate the propulsion system 26 to provide thrust such that the satellite 12 is removed from its orbit. The device controller 30 may include specialized hardware (e.g., a microprocessor or memory storage), software, or a combination of both configured to carry out the activities described herein.

The de-orbiting device 14 may further include a power system 36. The power system 36 may include at least one of a chemical battery, a solar energy converter, and a nuclear energy device. In some examples, the power system 36 includes both a power source, such as a solar energy converter or nuclear energy device, and power storage, such as a chemical battery, for storing energy produced by the power source. The power system 36 connects to the device controller 30 and the sensor system 32, and generally provides power to all subsystems of the de-orbiting device 14. In other words, the de-orbiting device 14 is independently powered relative to the satellite 12, and operation of the de-orbiting device 14 is not reliant on any power system of the satellite 12.

In examples, a housing 37 of the de-orbiting device 14 contains and/or mounts the propulsion system 26, the device controller 30, the sensor system 32, and the power system 36. In an example, the housing 37 of the de-orbiting device 14 is attached to the housing 22 of the satellite 12.

In an example, in addition to facilitating de-orbiting, the positioning sensor 34 may be operable to continuously communicate signals that are representative of real-time position and movement characteristics of the satellite 12 to the device controller 30. In examples, the satellite 12 may be designed to orbit with a constant orientation relative to Earth or may orbit while spinning about an axis of the satellite 12 with a constant orientation relative to Earth. The satellite 12 may also be geostationary under normal operating conditions. The device controller 30 may store orbital parameter data representative of a range of position and movement characteristics of the satellite 12 under these normal, intended operating conditions. An inoperability of the satellite 12, such as the satellite 12 tumbling or being in an unstable orientation, may be indicated by the real-time position and movement characteristics of the satellite 12 deviating from the stored orbital parameter data for a continuous length of time that is greater than an orbital parameter time threshold. The device controller 30 may be configured to activate the propulsion system 26 for de-orbiting in response to this deviation.

In addition, or alternatively, the positioning sensor 34 may monitor for a lack of station keeping activities by the satellite 12. For example, the positioning sensor 34 may be operable to communicate signals representative of acceleration of the satellite 12. If no acceleration is detected for a period of time, then the propulsion system 26 of the satellite 12 has not activated to produce thrust during that period. In an example, the device controller 30 may be configured to activate the propulsion system 26 de-orbiting in response to the acceleration being zero for a continuous length of time that is greater than an acceleration time threshold.

The sensor system 32 may further include a heat sensor 38, which may be, for example, an infrared (IR) camera or a thermocouple. The heat sensor 38 is operable to communicate signals to the controller that are representative of a temperature of the satellite 12. The satellite 12 in this example includes a heat rejection location 40. The heat rejection location 40 may be located on the housing 22 proximate to a power source of the satellite 12, or generally may be any warm spot occurring due to normal operation of heat-producing components of the satellite 12. The device controller 30 may be programmed to store data relating to normal temperature measurements of the heat rejection location 40 taken by the heat sensor 38 when the satellite 12 is operating. When the satellite 12 is not operating, heat-producing components of the satellite 12 will stop functioning and therefore stop producing heat in the heat rejection location 40. The device controller 30 may compare an instant temperature of the heat rejection location 40 occurring in real-time to the stored temperature data to determine whether the satellite 12 is operational. In other examples, the device controller 30 stores a temperature threshold of the heat rejection location 40, and the device controller 30 is configured to activate the propulsion system 26 for de-orbiting in response to the instant temperature measured by the heat sensor 38 being below the temperature threshold for a continuous length of time that is greater than a temperature time threshold.

In a further example, sensor system 32 may include an electrical current sensor 42, such as a Hall effect sensor. The electrical current sensor 42 is operable to communicate electric current signals that are representative of status of an electrical system of the satellite 12 to the device controller 30. In examples, the current sensor 42 monitors the satellite controller 18. When the satellite 12 is operating, electrical currents run through the satellite controller 18 and other electrical systems of the satellite 12. These electrical currents ceasing for a prolonged period indicates that the satellite 12 has become inoperable. The device controller 30 may be configured to activate the propulsion system 26 for de-orbiting in response to the status of the electrical system indicating an absence of electrical activity for a continuous length of time that is greater than an electrical activity time threshold.

In a further example, the sensor system 32 may include a communication system 44. In an example, the communication system 44 may comprise a wireless receiver operable to receive external instruction signals from the satellite 12 or from another external source, such as a terrestrial control station or a second, different satellite. In other examples, the communication system 44 comprises a direct wired connection with the satellite 12 such that the satellite controller 18 may communicate with the device controller 30 of the de-orbiting device 14. Accordingly, the device controller 30 may be configured to initiate de-orbiting in response to an external instruction signal from the satellite 12 itself or another external source. Such external de-orbiting instructions may be sent if the satellite 12 itself or another external source detects that the satellite 12 is no longer operational, that a useful function of the satellite 12 is no longer needed, or that it is desirable to de-orbit the satellite 12 for any other reason beyond the de-orbiting indications monitored by the de-orbiting device 14.

In some examples, the satellite 12 is configured to transmit and the communication system 44 is configured to receive a satellite health signal which is indicative of satellite operability. The satellite 12 is configured to transmit the health signal periodically, for example, every minute or every hour. The satellite 12 continuously effectuating this periodic ping indicates that the satellite 12 is operational. Conversely, if the periodic health signal is not received by the communication system 44 when expected then an inoperability of the satellite 12 may be indicated. In an example, the device controller 30 is configured to activate the propulsion system 26 for de-orbiting in response to an absence of receipt of the satellite health signal for a continuous length of time that is greater than a health signal time threshold.

The communication system 44 may also monitor outbound signals transmitted by the satellite 12, for example, outbound radio frequency transmissions to a terrestrial control station or a second, different satellite. When operation, the satellite 12 may be configured to transmit signals to external sources, for example to perform a useful function as described above. If the satellite 12 becomes inoperable then the satellite may cease to transmit outbound signals. The communication system 44 in this example is operable to communicate signals that are representative of a communication status of the satellite 12 to the device controller 30. The device controller 30 may be configured to activate the propulsion system 26 for de-orbiting in response to the communication status indicating an absence of outbound communication from the satellite 12 for a continuous length of time that is greater than an outbound communication time threshold. In an example, the communication system 44 monitors both the periodic satellite health signal transmitted by the satellite 12 and outbound communications of the satellite 12.

In an example, the periodic satellite health signal is the only communication between the de-orbiting device 14 and the satellite 12. In other examples, the de-orbiting device 14 is completely separate from the satellite 12 and does not communicate with the satellite controller 18 in any manner. The device controller 30 of the de-orbiting device 14 may also be “autonomous” relative to the satellite controller 18, meaning that the controller 30 of the de-orbiting device does not receive instructions from the satellite controller 18 nor require any input from the satellite controller 18 in order to operate. While these configurations limit some monitoring functions of the de-orbiting device 14, additional communication between the satellite 12 and de-orbiting device 14 may introduce complexity and interference.

In a further example, the device controller 30 may include a timer 46. The timer 46 is programmed with an expiration time period of the satellite 12 prior to launch of the satellite 12. The device controller 30 may be configured to activate the propulsion system 26 for de-orbiting in response to the expiration time period elapsing.

The expiration time period is associated with an intended life-span of the satellite 12. For example, the expiration time period may be associated with an expected design-life of the satellite, or an amount of time before the occurrence of a satellite inoperability may be expected. In other examples, the expiration time period is associated with a mission life of the satellite, i.e., the length of time required to complete the useful purpose of the satellite 12. In other examples, the expiration time period is not associated with a design-life or mission life of the satellite 12, and is intended for voluntary removal of the satellite 12, for example, to avoid accumulation of space debris or for replacement with a new satellite. In an example, the expiration time period is about six years from the launch of the satellite 12.

It should be understood that the above described sensors 34, 38, 42, 44 and de-orbiting methods of the de-orbiting device 14 may be used in combination, such that the device controller 30 monitors for the various de-orbiting indications described above concurrently. As will be discussed further below, the device controller 30 is configured to instruct de-orbiting if one or more of the above described de-orbiting indications suggest that the satellite 12 is inoperable.

In an example, the de-orbiting device 14 may also be used as a collision avoidance system. The sensor system 32 may further include a proximity sensor 48 operable to communicate avoidance signals to the device controller 30. The proximity sensor 48 continuously monitors the area surrounding the satellite 12. The avoidance signals are representative of potential collisions, such as incoming space objects in close proximity to the satellite 12 or on a collision course with the satellite 12. The device controller 30 may be configured to instruct the propulsion system 26 and thus the thruster 28 to activate in response to the avoidance signals. More specifically, the device controller 30 may control the thrust vector T provided by the propulsion system 26 to remove the satellite 12 from the path of the detected space object based on the avoidance signals in combination with position and movement characteristics of the satellite 12 received from the positioning sensor 34. In addition, or alternatively, the de-orbiting device 14 may receive avoidance signals via the communication system 44 from the satellite 12 or another external source to initiate an instructed collision avoidance maneuver.

In examples, the thrusters 20 of the satellite propulsion system 16 may be electric propulsion (EP) thrusters, or other type of thruster which can only produce relatively low levels of thrust and therefore cannot make timely necessary collision avoidance maneuvers. Thus, in examples, the propulsion system 26 of the de-orbiting device 14 may include a higher overall thrust rating than the satellite propulsion system 16. The de-orbiting device 14 being operable to produce a thrust vector T through the center of gravity C_{g} of the satellite 12 also facilitates maneuverability. Accordingly, the de-orbiting device 14 may be able to accomplish collision avoidance maneuvers which the satellite 12 could not achieve on its own.

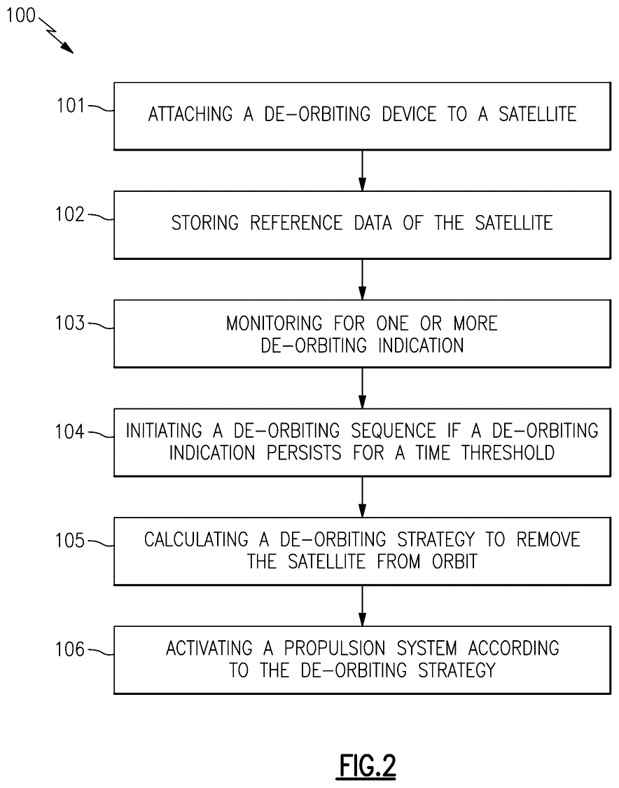

FIG. 2 illustrates a method 100 for de-orbiting a satellite 12 in orbit using the de-orbiting device 14. At step 101, a de-orbiting device 14 is attached to the satellite 12 prior to launching the satellite 12 into space. Step 101 may include fastening, strapping, tethering, or adhering the de-orbiting device 14 to the satellite 12. Step 101 may further include aligning the de-orbiting device 14 on the satellite 12 such that a thrust vector T produced by a propulsion system 26 of the de-orbiting device 14 will extend through or extend proximate to a center of gravity C_{g} of the satellite 12.

At step 102, reference data relating to an intended operating state of the satellite 12 is stored in a device controller 30 of the de-orbiting device 14. At step 103, at least one sensor 34, 38, 42, 44 of the de-orbiting device 14 monitors for one or more de-orbiting indications and communicates representative signals to the device controller 30. The de-orbiting indications of step 103 may comprise (1) a temperature of the satellite 12 deviating from the reference data, (2) a status of an electrical system of the satellite 12 deviating from the reference data, (3) the satellite 12 failing to transmit a period satellite health signal according to the reference data, (4) an outbound communication status of the satellite 12 deviating from the reference data, (5) position and movement characteristics of the satellite 12 deviating from the reference data, (6) a lack of station keeping activities of the satellite 12 according to the reference data, and or (7) an expiration time period elapsing.

At step 104, the device controller 30 initiates a de-orbiting sequence in response to the de-orbiting indications persisting for a continuous length of time that is greater than a time threshold stored by the device controller 30. In examples, the time threshold may be a week, a month, or six months, however any appropriate time period may be used. Requiring the de-orbiting indication to persist for a continuous length of time greater than a time threshold increases the likelihood that the satellite 12 is permanently rather than temporarily inoperable. Further, the delay provided by the time threshold may allow for intervention from an external source if the external source determines that de-orbiting is not desired, for example if it is determined that the satellite 12 may be serviced or repaired to correct the de-orbiting indication.

It should be understood that a separate and different time threshold may be applied by the device controller 30 for each of the above described de-orbiting indications. For example, for the respective de-orbiting indications described above the device controller 30 may store (1) a temperature time threshold, (2) an electrical activity time threshold, (3) a health signal time threshold, (4) an outbound communication time threshold, (5) an orbital parameter time threshold, and (6) an acceleration time threshold. In other examples, the time threshold is the same for each of the above described de-orbiting indication.

Step 104 may also include the intermediate step of communicating with an external source to obtain confirmation that de-orbiting is desired. If a de-orbiting indication persists for a relevant time threshold, the device controller 30 may instruct the communication system 44 to communicate a signal indicative of that de-orbiting indication to an external source. The device controller 30 initiates the de-orbiting sequence in response to the communication system 44 receiving a confirmation signal from the external source.

At step 105, the device controller 30 calculates a de-orbiting strategy to remove the satellite 12 from orbit based on the position and movement characteristics of the satellite 12 communicated by the positioning sensor 34. Step 105 may include the device controller 30 determining a direction to orient the thrusters 28 of the propulsion system 26 and an amount of thrust to be provided by the thrusters 28 such that the satellite 12 will leave its orbit, and in some examples safely return to Earth. In some examples, the device controller 30 calculates a de-orbiting trajectory such that the satellite 12 will land on Earth in a remote location, such as in the middle of an ocean. At step 106, the device controller 30 activates and controls the propulsion system 26, including activating the thrusters 28, according to the de-orbiting strategy.

The de-orbiting systems 10 according to this disclosure provide a solution that may be easily added on to a satellite design to satisfy de-orbiting requirements. The de-orbiting device 14 according to this disclosure is a self-contained system and advantageously does not need any interface or input from the satellite 12 to function except for a physical connection to the satellite 12. The de-orbiting device 14 may also advantageously accomplish de-orbiting in situations where the primary satellite propulsion systems 16 or satellite controller 18 are not operational. In prior designs, such inoperability would leave the satellite 12 stranded in orbit as space debris. Further, incorporation of the de-orbiting device 14 removes a requirement that fuel or propellant of the satellite 12 be saved until the end of the intended life of the satellite 12 to accomplish de-orbiting. The de-orbiting device 14 may also advantageously serve as a collision avoidance system, which is especially advantageous in situations where the satellite propulsion system 16 cannot accomplish avoidance maneuvers.

Although a combination of features are shown in the illustrated example, not all of them need to be combined to realize the benefits of the various examples of this disclosure. In other words, a system designed according to an example of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

1. A satellite de-orbiting device comprising:
at least one thruster;
at least one sensor;
a controller configured to communicate with the at least one thruster and the at least one sensor, wherein
the de-orbiting device is configured to be attached to a satellite,
the at least one sensor is operable to communicate signals to the controller that are representative of at least one of temperature of a satellite, position of a satellite, movement characteristics of a satellite, or communication status of a satellite, and
the controller is configured to activate the at least one thruster for de-orbiting based on at least one of the temperature, the position, the movement characteristics, or the communication status.

2. The satellite de-orbiting device of claim 1, wherein the signals are representative of the temperature.

3. The satellite de-orbiting device of claim 2, wherein the controller is configured to activate the at least one thruster in response to the temperature being below a temperature threshold for a continuous length of time that is greater than a temperature time threshold.

4. The satellite de-orbiting device of claim 2, wherein the sensor includes an infrared camera.

5. The satellite de-orbiting device of claim 1, wherein the signals are representative of the position and the movement characteristics.

6. The satellite de-orbiting device of claim 5, wherein the controller is configured to activate the at least one thruster in response to the position and the movement characteristics deviating from an orbital parameter data for a continuous length of time that is greater than an orbital parameter time threshold.

7. The satellite de-orbiting device of claim 5, wherein the movement characteristics comprise an acceleration, the signals represent the acceleration, and the controller is configured to activate the at least one thruster in response to the acceleration being zero for a continuous length of time that is greater than an acceleration time threshold.

8. The satellite de-orbiting device of claim 1, wherein the signals are representative of the communication status, and the controller is configured to activate the at least one thruster in response to the communication status indicating an absence of outbound communication for a continuous length of time that is greater than an outbound communication time threshold.

9. The satellite de-orbiting device of claim 1, wherein the de-orbiting device further includes a battery connected to the controller and the at least one sensor.

10. The satellite de-orbiting device of claim 1, further comprising an electric current sensor operable to communicate current signals that are representative of a status of an electrical system to the controller, and the controller is configured to activate the at least one thruster in response to the status of the electrical system indicating an absence of electrical activity for a continuous length of time that is greater than an electrical activity time threshold.

11. The satellite de-orbiting device of claim 1, wherein the controller includes a timer that has an expiration time period, and the controller is configured to activate the at least one thruster in response to the expiration time period elapsing.

12. The satellite de-orbiting device of claim 1, wherein the controller is configured receive a periodic satellite health signal, the presence of which is indicative of satellite operability, and the controller is configured to activate the at least one thruster in response to an absence the satellite health signal for a continuous length of time that is greater than a health signal time threshold.

13. The satellite de-orbiting device of claim 1, wherein the controller is configured to receive avoidance signals that are indicative of a potential collision, and the controller is configured to activate the at least one thruster in response to the avoidance signals.

14. The de-orbiting device of claim 1, wherein the controller is configured to activate the at least one thruster in response to an external instruction signal.

15. A method for de-orbiting a satellite comprising:
monitoring at least one of a temperature of a satellite, position of a satellite, movement characteristics of a satellite, or communication status of a satellite; and
initiating a de-orbiting sequence responsive to at least one of:
the temperature being below a temperature threshold for a continuous length of time that is greater than a temperature time threshold,
the position and the movement characteristics deviating from an orbital parameter data for a continuous length of time that is greater than an orbital parameter time threshold, or
the communication status indicating an absence of outbound communication for a continuous length of time that is greater than an outbound communication time threshold.

16. The method of claim 15, further comprising attaching a de-orbiting device to a satellite.

17. The method of claim 16, wherein:
the monitoring includes using a sensor on the de-orbiting device to communicate signals that are representative of the temperature, the position, the movement characteristics, or the communication status to a de-orbiting device controller;
the initiating includes the de-orbiting device controller initiating the de-orbiting sequence based on the signals; and
the de-orbiting sequence includes activating a thruster on the de-orbiting device.

18. A system comprising:
a satellite;
a de-orbiting device attached to the satellite, the de-orbiting device including:
at least one thruster,
at least one sensor, and
a controller communicating with the at least one thruster and the at least one sensor, wherein
the at least one sensor is operable to communicate signals to the controller that are representative of at least one of temperature of the satellite, position of the satellite, movement characteristics of the satellite, or communication status of the satellite, and
the controller is configured to activate the at least one thruster for de-orbiting based on at least one of the temperature, the position, the movement characteristics, or the communication status.

19. The system of claim 18, wherein the satellite includes a satellite controller, and wherein the controller of the de-orbiting device is autonomous relative to the satellite controller.

20. The system of claim 18, wherein the satellite includes at least one thruster, the at least one thruster of the de-orbiting device including a higher thrust rating than the at least one thruster of the satellite.
